(19) United States
(12) Patent Application Publication
(10) Pub. No.: US 2006/0288194 A1
(43) Pub. Date: Dec. 21, 2006

(54) Real-time processor

(75) Inventors: James M. Lewis, Moulton, AL (US); Shayle Hirschman, Huntsville, AL (US)

Correspondence Address: WELSH & FLAXMAN LLC, 2000 DUKE STREET, SUITE 100, ALEXANDRIA, VA, 22314, US

(73) Assignee: Lewis Innovative Technologies

(21) Appl. No.: 11/240,535

(22) Filed: Oct. 3, 2005

Related U.S. Application Data
(60) Provisional application No. 60/691,242, filed on Jun. 17, 2005.

(51) Int. Cl. G06F 15/00

(52) U.S. Cl. 712/220

(57) ABSTRACT

A real-time processor for a data processing system includes a continuous clock counter, an instruction parser parsing instructions based upon whether they a clock command or no timing specific instruction, a clock comparator only operating upon instructions including a clock command and an execution mechanism for executing a series of instructions in a timely manner based upon absolute timing of the clock counter such that events may be scheduled from the beginning of a sequence.

### CROSS REFERENCE TO RELATED APPLICATIONS

This application is based upon U.S. Provisional Patent Application Ser. No. 60/691,242, filed Jun. 17, 2005, entitled “REAL-TIME PROCESSOR”.

### BACKGROUND OF THE INVENTION

1. Field of the Invention

The invention relates to a real-time processor. More particularly, the invention relates to a real-time processor that controls the execution of instructions for timely implementation. In addition, the invention relates to the use of a real-time processor in controlling time critical processes employed in industrial and military applications.

2. Description of the Prior Art

As computer systems have become responsible for handling a wide variety of industrial and military applications, the underlying systems developed for these applications have become more and more complicated. With the ever-developing complexity of these systems, the time critical execution of various instructions associated with the proper implementation of these systems has become very important.

However, current off-the-shelf processors do not provide for the ability to adequately control these programs in which time critical execution of instruction is of the utmost importance. With this in mind, a need exists for a processor ensuring the execution of computer based instructions optimizing the performance of these complex systems. The present invention provides such a processor.

### SUMMARY OF THE INVENTION

It is an object of the present invention to provide a real-time processor for a data processing system. The real-time processor includes a continuous clock counter, an instruction parser parsing instructions based upon whether they are a clock command or no timing specific instruction, a comparator only operating upon instruction including a clock command and a mechanism for executing a series of instruction in a timely manner based upon absolute timing of the clock counter such that events may be scheduled from the beginning of a sequence.

It is also an object of the present invention to provide a launch station test set which emulates a control system and missiles to step the launcher through a simulated launch with time critical issues. The launch station test set includes a missile launcher, a missile simulator and a real time processor as discussed above.

It is another object of the present invention to provide an engagement control system—factory test emulator which emulates precision signals issued over a serial data link, the signals and serial data link being synchronized due to serial messages such that missiles are synchronized with messages to operate in tandem. The system includes a launching system and a real time processor as discussed above.

It is another object of the present invention to provide a real-time processor for a data processing system. The real-time processor includes a continuous clock counter, an instruction parser parsing instructions based upon whether they are an input instruction, and an input operator which has the ability to execute an input instruction upon receipt of an input signal and the output operator.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present real-time system which includes the real time processor.

FIG. 2 is a detailed schematic of the present real-time processor.

FIGS. 3, 4, and 5 are timing diagrams that illustrate the execution of instructions in accordance with the present invention.

FIGS. 6 and 7 are exemplary instructions employed in accordance with the present invention.

FIG. 8 is a schematic of Launch Station Test Set system employing a real-time processor in accordance with the present invention.

FIG. 9 is a schematic of an Engagement Control System—Factory Test Emulator system employing a real-time processor in accordance with the present invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

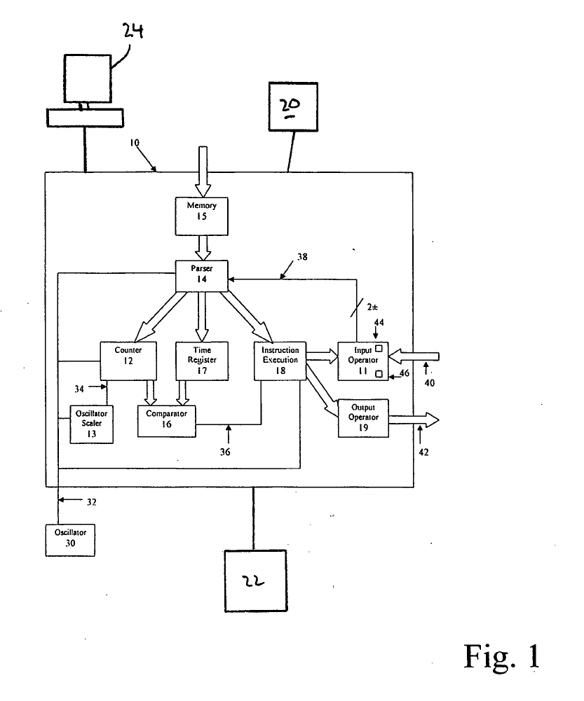

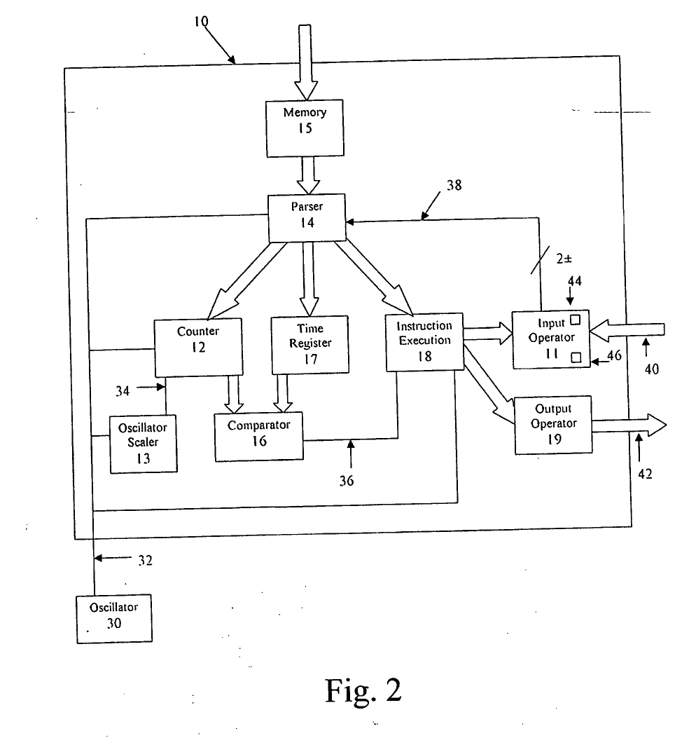

With reference to FIGS. 1 and 2, a real-time processor 10 for a data processing system is disclosed. The real-time processor 10 is designed for controlling time critical operations employed in industrial and military applications in a reliable and efficient manner. The real-time processor 10 includes a continuous clock counter 12, an oscillator scaler 13 to allow the clock counter 12 to increment on specific time intervals, an instruction parser 14 parsing computer program instructions based upon whether they include a clock command, a delay command, or no timing specific instruction, a memory 15, a clock comparator 16 only operating upon instructions including a clock command or a delay command, a time register 17, and an instruction execution mechanism 18 for executing a series of instructions in a timely manner based upon absolute timing of the clock counter 12 such that events and instructions associated with the proper operation of an application 22 (for example, the Launch Station Test Set or Engagement Control System—Factory Test Emulator (ECS FTE) discussed below in greater detail) may be scheduled from the beginning of a sequence. The real-time processor 10 further includes an input operator 11, an output operator 19 and various control and communication signals and signal busses. FIG. 1 also shows a PC or other system 24 for loading compiled programs into the processor memory 15.

In operation, and as discussed below in greater detail, a compiled program (executable) is loaded into the memory 15 and the instruction parser 14 begins execution of the program. As illustrated in FIG. 2, the instruction parser 14 sets or pre-sets the clock counter 12 by loading the appropriate data bits from a “WRITE_clock” instruction. If a “CLOCK” instruction (that is, a clock command) is encountered, the time the instruction associated with the clock command will execute is loaded into the time register 17. All other instructions are fetched from the memory 15 and the appropriate bits transferred to the instruction execution unit 18.

When a clock command is encountered, the appropriate time value is transferred to the time register 17 and the next instruction is loaded into the instruction execution unit 18. The instruction execution unit 18 is inhibited from executing the instruction by an inhibit control signal 36. When the value of the clock counter 12 matches the value of the time register 17, the clock comparator 16 de-asserts the inhibit control signal 36.

The present real-time processor 10 is synchronized to an oscillator 30. Appropriate distribution of the oscillator signal 32 allows the instruction parser 14 and other units to operate properly. The oscillator scaler 13 allows the clock counter 12 to operate on time intervals shorter than the primary oscillator frequency. The oscillator scaler 13 allows the clock counter 12 to increment on the proper time intervals by controlling the counter enable signal 34. The oscillator scaler 13 may be controlled by special instructions stored in the memory 15 and interpreted by the instruction parser 14. Oscillator scaling instructions are expressly anticipated for future implementations so that the timing interval may be dynamically adjusted.

The clock counter 12, or master clock, in accordance with a preferred embodiment of the present invention, works in conjunction with the instruction parser 14, clock comparator 16, time register 17, and instruction execution mechanism 18 so the instructions are executed at exactly the time specified in accordance with the instructions. The clock counter 12 is incremented under the control of the oscillator scaler 13 on specific time intervals, for example, seconds, milliseconds or microseconds, and the clock commands are, therefore, incremented with the specific time intervals considered by the clock counter 12.

In practice, the clock counter 12 counts “ticks” generated by the oscillator 30 when enabled by the oscillator scaler 13 via the counter enable signal 34 and translates these “ticks” into a count time based upon predetermined increments applied in accordance with specific functions for which the present processor 10 is applied. This method is basically the same as scaling the oscillator signal 32, but allows for a more synchronous system as is commonly practiced in high speed digital electronics today. Dividing the oscillator frequency and providing this slower oscillator to the clock input of the clock counter 12 would provide the same effect but is slightly less synchronous and can cause problems at high oscillator frequencies.

For instance, if the clock counter 12 is to increment in milliseconds, the oscillator scaler 13 provides a counter enable signal (or oscillator scaler output) 34 once every millisecond allowing the clock counter 12 to count an oscillator “tick” generated each millisecond by the oscillator 30. This counting will be used to identify the passage of milliseconds and the clock commands employed in the instruction set will be incremented in milliseconds.

Operation of the present real-time processor is enhanced by the ability to set the oscillator scaler 13 from a program instruction as discussed above. The oscillator scaler 13 allows the clock counter 12 to increment on the proper time intervals by controlling the counter enable signal 34. The oscillator scaler 13 may be controlled by special instructions stored in the memory 15 and interpreted by the instruction parser 14. Oscillator scaling instructions are expressly anticipated for future implementations so that the timing interval may be dynamically adjusted.

As will be discussed below in greater detail, the clock counter 12 operates continuously to provide for absolute time during the execution of a series of instructions. That is, the clock counter 12 starts at some “Time 0” and all clock command and/or delay command instructions are thereafter referenced exactly to “Time 0.” As is discussed below in greater detail, the present processor 10 only resets the clock counter 12 at the beginning of long sequences or at the beginning of a loop iteration under the specific control of the “WRITE_Clock” command. Due to this, the present real-time processor 10 utilizes absolute timing so that events can be scheduled exactly from the beginning of a sequence or the beginning of a loop iteration. The present real-time processor 10 allows for the explicit reset of the clock counter 12 and only resets the clock counter 12 when explicitly commanded.

Further, because of the implementation of the oscillator scaler 13, the clock counter 12 always remains synchronized to the specific time increment that is being used. When a “WRITE_Clock” instruction is encountered by the instruction parser 14, the instruction parser 14, operating at the frequency of the fast oscillator signal 32, writes the new counter value to the clock counter 12 and the clock counter 12 will still increment at the proper interval of time. Because of this, iterative loops of operations can be performed with exact timing in reference to each other.

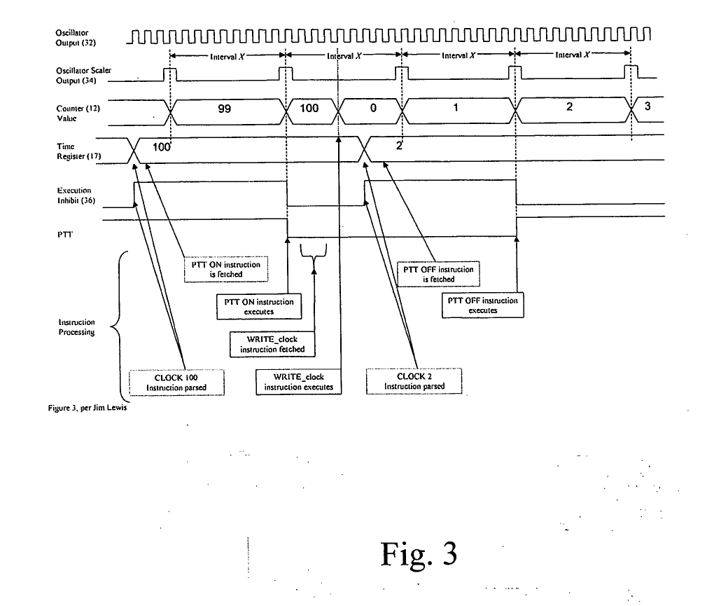

In FIG. 3 the timing of the “WRITE_Clock” and “CLOCK” instructions is illustrated for the following instruction sequence:

```
CLOCK 100
    PTT ON
    WRITE_Clock 0
CLOCK 2
    PTT OFF
```

As illustrated in FIG. 3, the partial sequence above is executed in the following manner. After all previous instructions have been executed, the “CLOCK 100” instruction is parsed by placing the value “100” in the time register 17 and asserting the execution inhibit control signal 36 to the instruction execution unit 18. Next, the “PTT ON” instruction (that is, “Push To Talk”) is parsed and appropriate values transferred to the instruction execution unit 18. The “PTT ON” instruction is not executed because the instruction execution unit 18 is inhibited by the execution inhibit control signal 36. When the clock counter 12 value and the time register 17 values become equal, the clock comparator 16 clears (de-asserts) the execution inhibit control signal 36 allowing the instruction execution unit 18 to immediately execute the “PTT ON” instruction which has already been loaded into its registers. Note that the PTT function is active low.

Next the “WRITE_clock 0” instruction is immediately executed, causing the value of the clock counter 12 to change to 0. At the next point in time when the oscillator scaler output 34 is true, the value of the clock counter 12 increments to 1. Counter incrementing is kept uniform by the oscillator scaler output 34 regardless of other instructions executed and the interval between each clock increment is always uniform as indicated by the Interval X dimension in FIG. 3.

As soon as the “WRITE_clock 0” instruction has been parsed, the next clock command (that is, “CLOCK 2”) is parsed. Because of the parsing of the “CLOCK 2” instruction, the value in the time register 17 is changed to 2 and the execution inhibit control signal 36 is activated. Now the “PTT OFF” instruction is parsed by loading the appropriate values into the instruction execution unit 18. Again, the instruction execution unit 18 performs no action at this time because of the execution inhibit control signal 36.

When the clock counter 12 value and the time register 17 values become equal (both equal to 2 in this example) the clock comparator 16 clears (de-asserts) the execution inhibit control signal 36 allowing the instruction execution unit 18 to immediately execute the “PTT OFF” instruction which has already been loaded into its registers.

The program segment and its execution described above demonstrate how the present real-time processor 10 executes instructions in an extremely timing accurate manner. This also demonstrates how a program loop can be constructed to repeatedly generate a precision signal for testing purposes or repeat a precision sequence of events for automation purposes.

As discussed above, the real-time processor 10 includes an instruction parser 14 parsing instructions based upon whether they include a clock command, a delay command or no timing specific instruction. With this in mind, the programmed instruction sets utilized in conjunction with the present real-time processor 10 may be provided with various commands including a clock command and/or a delay command. Clock commands are used to designate an absolute time at which the associated instruction should be executed by the processor 10. When a clock command is issued in conjunction with an executable instruction, the next following instruction is fetched from the memory 15 and prepared for execution. At this point, instruction execution is suspended until the clock counter 12 reaches the time specified in the clock command. As discussed above, when the clock counter 12 reaches the appropriate time, instruction execution is extremely fast and accurately timed due to the pre-fetching of the instruction.

The delay command allows for close synchronization to asynchronous events. When a delay command is encountered, the execution of the program is suspended for approximately the length of time indicated by the delay command. For instance, when a “Delay 100” instruction (that is, the delay command) is encountered, the real-time processor 10 inserts 100 clock counter 12 cycles of delay.

This is accomplished in the following manner. When the delay command is parsed, a value is loaded into the time register 17 that is equal to the present value in the clock counter 12 plus the value of the delay increment and the execution inhibit control signal 36 is asserted. As those skilled in the art will certainly appreciate, the process of adding the delay value from the instruction to the counter value is easily accomplished in the instruction parser 14 with a digital adder (not shown) of appropriate size for the two values. This process is easily accomplished in programmable logic or in hard silicon and easily designed using either schematic techniques or hardware description language. The next instruction is parsed to the instruction execution unit 18 just as in the case of the clock command.

When the clock comparator 16 determines that the value in the clock counter 12 equals the value in the time register 17, the instruction inhibit control signal 36 is de-asserted and the parsed instruction waiting in the instruction execution unit 18 is allowed to execute.

The utility of the delay command is related to timely reaction to external events. In accordance with a preferred embodiment of the present invention, the real-time processor 10 includes an input operator 11. There are various input functions and instructions designed into the two existing implementations. Some of these operate on parallel data (or single event inputs) and some of these operate on serial data or multiple event data streams.

When the instruction parser 14 decodes an “INPUT” instruction, the instruction execution unit 18 loads information on the expected input into the input operator 11. The input information includes details on what input signal(s) the input is expected on, whether any change or a specific value is expected, and how long to wait for the input event. The input operator 11 includes its own mechanism for comparing a target time against the clock counter 12 and thereby providing a timing window during which the input event is expected. This function is implemented with a time register 44 and comparator 46 within the input operator 11 similar to time register 17 and clock comparator 16. The comparator 46 in the input operator 16 also compares its respective time register 44 to the clock counter 12. This mechanism allows the input operator 11 to recognize a “time window” and to “look” for an input (incoming event) during a specific time window. If the event occurs during the specified window, the program execution continues to the next instruction. If the event does not occur during the window, the program branches to an alternative execution path.

In the event that the input operator 11 detects the proper input during the time window specified, the program can execute a delay command that responds to the input in a precisely timed manner. The input could be an indication of the position of an object and the delayed command a mechanical operation timed to precisely operate on the object based on the timing of the input. The input could also be a communication message and the delayed response could be a responding message, precisely timed to emulate an actual response. The present implementations utilize both of these example cases.

The following example is presented for understanding and demonstrating the delay command and the input and output instructions.

```
CLOCK 10
    INPUT, X=1, WAIT 11, BRANCH XFAIL
    Delay 10
    Output Z( )=0x7A
    Write_clock 0
      •
      •
      •
:XFAIL
CLOCK 25
    Output Z( )=0x80
```

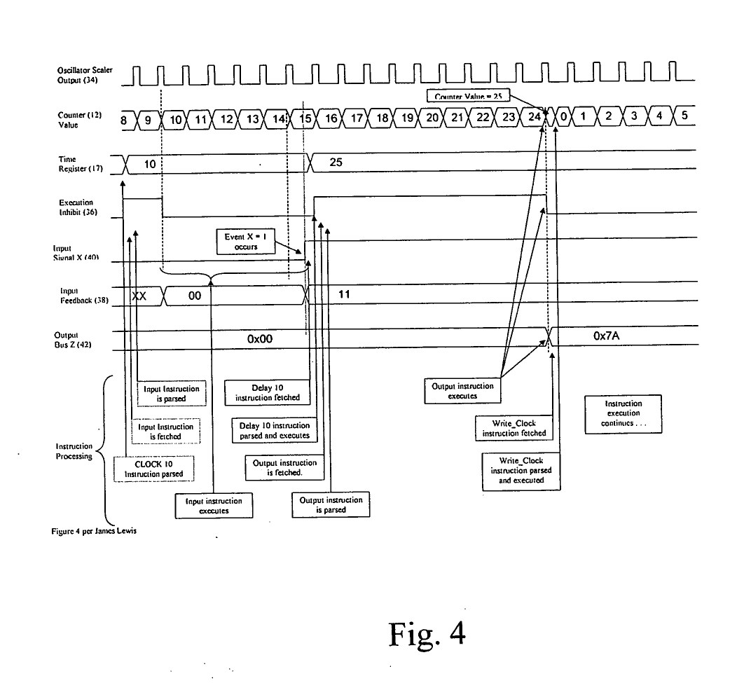

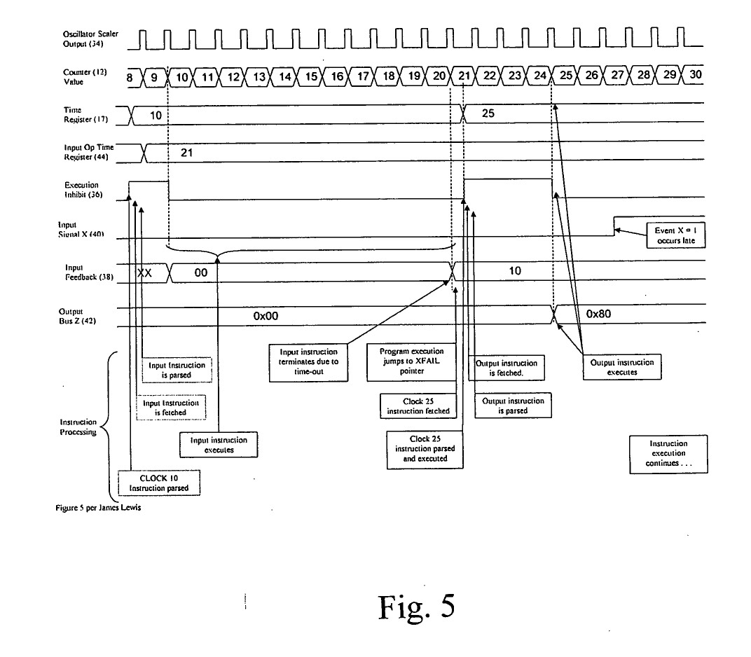

This program segment is executed with a successful input as illustrated in FIG. 4. In FIGS. 4 and 5 the clock signal is not shown for the sake of brevity. As demonstrated in FIG. 3, the clock counter 12 is allowed to increment by the oscillator scaler output 34. The clock in this example may be close to the magnitude of the oscillator scaler signal or many times faster.

After the execution of other instructions, the instruction parser 14 fetches and parses the instruction “CLOCK 10”. In keeping with the established operation of the clock command, the execution inhibit control signal 36 is asserted and the time register 17 is loaded with the value “10”. The “INPUT” instruction is then immediately fetched from memory 15 and parsed by loading the appropriate values into the instruction execution unit 18 and the input operator 11. When the “INPUT” instruction is parsed, the input feedback signals 38 are set to 00 (cleared from whatever value they may have held from a previous operation). As discussed previously, the “INPUT” instruction is not executed until the clock counter 12 reaches count value 10. When the clock counter 12 reaches count value 10, the clock comparator 16 de-asserts the execution inhibit control signal 36 and the “INPUT” instruction commences. The instruction parser 14 does not fetch any other instructions until the result of the “INPUT” operation is established.

When the Input Signal X 40 matches the expected value, the input operator 11 provides input feedback 38. The input feedback 38 may be as many or as few signals as required to communicate the input results. In the implementation described here, two input feedback terms are used, the most significant bit indicates that the input function has completed; the least significant bit indicates that the input is the expected value. Sometime during counter cycle 15, the input achieves the expected state and the input operator 11 provides input feedback 38 to the instruction parser 14.

After the instruction parser 14 receives the input feedback 38, the next instruction (“Delay 10”) is fetched from memory 15. The “Delay 10” instruction is parsed and executed which causes the execution inhibit control signal 36 to be asserted and the value 25 (clock counter 12 value plus delay value) to be loaded into the time register 17. It is contemplated the delay command may also be designed to load a value equal to the clock counter 12 value plus the delay value plus some constant. The constant may be equal to one to adjust the accuracy tolerance of the delay command. Additionally, the delay command may add the delay value times some constant to the clock counter 12 value in order to scale the function. The operation of the delay command is identical to the operation of the clock command after this point.

The instruction parser 14 now fetches and parses the “Output” function based on the successful outcome of the “INPUT” instruction. The appropriate values for the “Output” function are loaded into the instruction execution unit 18 and the output operator 19 but execution does not proceed due to the execution inhibit control signal 36. When the clock comparator 16 determines that the clock counter 12 matches the time register 17 value 25, the execution inhibit control signal 36 is de-asserted and the “Output” instruction executes forcing the output bus Z 42 to the hexadecimal value 0x7A. Next, the “Write clock 0” instruction is fetched, parsed, and executed so that the clock counter 12 exhibits a count value of 1 at the next count increment.

As demonstrated here, the delay command allows the present real-time processor 10 to produce responses to events (outputs) with precise timing relationship to external events (inputs). In the example shown with reference to FIG. 4, the Output Bus Z 42 changes value within 1 counter cycle of 10 counter cycles after the “INPUT” event. The increment of 10 counter cycles was dictated by the delay command. For a better accuracy, a smaller counter cycle may be selected. When the counter value in this example is changed due to the “Write_clock 0” instruction, the new counter values are referenced directly to the “Output” event and indirectly to the external event (input). The timing window for an event to occur may be very large (or infinite) or very small depending on the requirements of the particular system. The delay command therefore allows for close synchronization to asynchronous events.

FIG. 5 illustrates the execution of the same programming sequence if the expected input does not occur. As in FIG. 4, the “Clock 10” instruction is fetched from the memory 15 and parsed causing the execution inhibit control signal 36 to be asserted and the time register 17 to be loaded with the value 10. The “INPUT” instruction is next fetched from the memory 15 and parsed by instruction parser 14 but execution of the “INPUT” instruction does not proceed until the clock comparator 16 determines that the clock counter 12 value matches the time register 17 value, at which time the execution inhibit control signal 36 is de-asserted and the input operator 11 begins performing the “INPUT” function. No other instruction is fetched from memory 15 at this time (until the outcome of the “INPUT” instruction is determined).

The event or timing window of the “INPUT” function is implemented with a time register 44 and comparator 46 within the input operator 11 similar to time register 17 and clock comparator 16. The comparator 46 in the input operator 11 also compares its respective time register 44 to the clock counter 12. The input operator time register 44 is loaded with a value equal to the time register 17 value plus the “WAIT” value (11 for this example). The input operator time register 44 can be loaded when the “INPUT” instruction is parsed since the value in the time register 17 indicates the time the instruction will begin. The value in the input operator time register 44 indicates the time that the event window will expire. When the clock counter 12 reaches a value 21, the “INPUT” function terminates due to the expiration of the event window. When the event window expires, the instruction is said to have “timed out”. Because of the “timed out” situation without an acceptable input, the input operator 11 produces input feedback 38 of value 10. The most significant bit indicates that the “INPUT” function has terminated, the least significant bit (a zero in this case) indicates that the expected input did not occur.

Based on the input feedback 38 values, the instruction parser 14 requests the instruction stored at the memory location indicated by the “XFAIL” pointer. In this implementation of the “INPUT” instruction, the “BRANCH” pointer is taken on an instruction failure (“BRANCH” on fail). The instruction branched to is a “CLOCK 25” instruction which will inhibit the next instruction from executing until the clock counter 12 reaches a value of 25. It is significant to note that in the case of a missed input, the counter value need not be reset; the system is still synchronized.

The “CLOCK 25” instruction is fetched from memory 15 and parsed by instruction parser 14 which includes asserting execution inhibit control signal 36 and loading the value 25 into time register 17. Next the “Output” instruction is fetched from memory 15 and parsed by instruction parser 14. The appropriate values are loaded into the instruction execution unit 18 and output operator 19 but execution is inhibited. When the clock comparator 16 determines that the clock counter 12 value matches the time register 17 value, the execution inhibit control signal 36 is de-asserted and the value 0x80 is output on output bus Z 42.

As briefly discussed above, the timely fetching and execution of instructions is achieved by a clock comparator 16 only operating upon instructions including a clock command or a delay command and an execution mechanism 18 for executing a series of instructions in a timely manner based upon absolute timing of the clock counter 12 such that events may be scheduled from the beginning of a sequence.

The preferred syntax employed when specifying a clock command in accordance with the present invention is as follows:

CLOCK [Value]
Where Value = Integer 0 to 2ⁿ − 1 ( for n-bit operand)

Description—CLOCK declares the time when an action is to take place. Time referenced by the CLOCK instruction is in reference to the interval determined by the oscillator scaler.
The WRITE_clock instruction allows the counter value to be reset to zero or to any other value.

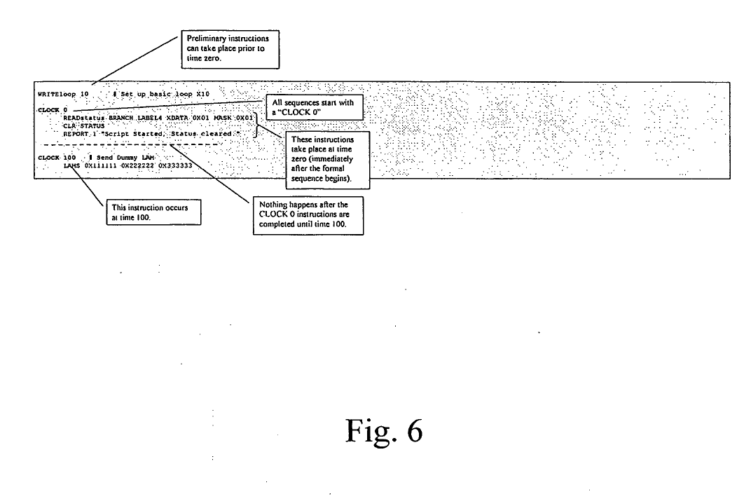

An example of executable instructions in conjunction with the present processor is presented below with reference to FIG. 6. The example shows a preliminary instruction taking place prior to Time 0. The preliminary instruction is “WRITEloop 10”. Thereafter, a sequence begins with a “Clock 0”. After the clock is set at zero, instructions take place at a Time 0 (that is, immediately after the formal sequence begins). Thereafter, nothing happens until Time 100 at which time instruction “LAMS 0X808A0A 0x800001 0X0” is initiated. The “LAMS” instruction (Launcher Action Messages) is a serial output function.

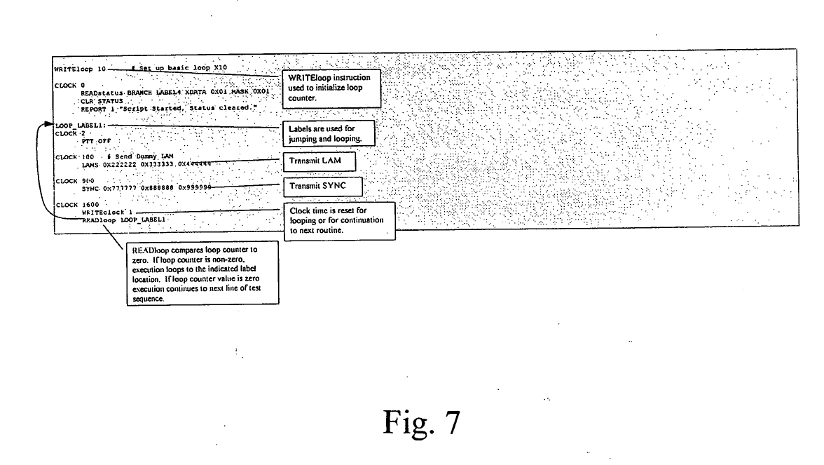

Referring to FIG. 7, an example program from an Engagement Control System—Factory Test Emulator (ECS-FTE) is disclosed. The example shows multiple instructions after clock commands. In these cases, the first instruction immediately following the clock command is executed exactly at the time indicated (such as, “READstatus” after “CLOCK 0”), and the next instruction is executed immediately following (such as, “PTT ON” after “CLOCK 0”) as it does not have an associated clock command and, therefore, is executed immediately after the preceding instruction whether or not that command is associated with a clock command.

Instructions are implemented sequentially (just like a typical processor) until the next clock command occurs (in this case “CLOCK 2”) at which point the processor 10 fetches the next instruction from memory 15 and places the appropriate values in the processor registers (as described in detail earlier). Instruction execution is again suspended until the clock counter 12 reaches the appropriate time (“CLOCK 2” or 2 milliseconds in this example).

The “wRITEclock” command at “Clock 1600” resets the clock counter 12 and the “READloop” instruction serves as a loop that forces execution back to the point indicated by “LABEL1:”. In this manner, a highly repetitive operation can be easily implemented. In the system implemented in these examples, most of the instructions are real world output and input. For example, PTT (Push To Talk), a single event output, turns on an open collector switch; LAMS and SYNC instructions output detailed serial data packets.

Both of the existing implementations of this processor are realized in field programmable gate arrays (FPGA), although the present processor may be implemented in various programmable logic devices. In addition, the present real-time processor is implemented using various Hardware Descriptive Languages, for example, AHDL and VHDL, although other programming languages or schematic design technique may be used without departing from the spirit of the present invention.

In accordance with a preferred embodiment of the present invention, the real-time processors 10 of the present invention utilize a PC 24 to compile the instruction sequences (programs) into machine code. The compiled program (executable) is transferred from the PC 24 to the present real-time processor 10 and stored in memory 15 until the PC 24 instructs the real-time processor 10 to execute the program. As those skilled in the art will certainly appreciate, these components making up the present system may be separate or integrated into a single housing. The various implementations differ in the various input and output functions that are implemented, but they are identical in the use and implementation of the clock and delay command.

In accordance with a preferred embodiment of the present invention, the clock command is implemented using a clock comparator 16 employing a time register 17 that is loaded with the value from the clock command. The value in the time register 17 is compared to the current value of the clock counter 12. When the values match (as indicated by the clock comparator 16), a control signal 36 is exerted that allows the execution of the suspended instruction to proceed. This simple implementation allows for extremely accurate timing of signals for real time interfaces such as factory automation and emulation of real world hardware for test purposes.

As mentioned above and in accordance with a preferred embodiment of the present invention, operation of the present processor is achieved using Hardware Description Languages. The implementations described below are both achieved using AHDL (Altera Hardware Description Language). In accordance with a first embodiment (that is, the fist processor used in a Launch Station Test Set (LSTS)), it was implemented in an Altera 10K50 FPGA. The second embodiment (that is, the second processor used in an Engagement Control System—Factory Test Emulator (ECS FTE)) was implemented in an Altera Cyclone FPGA.

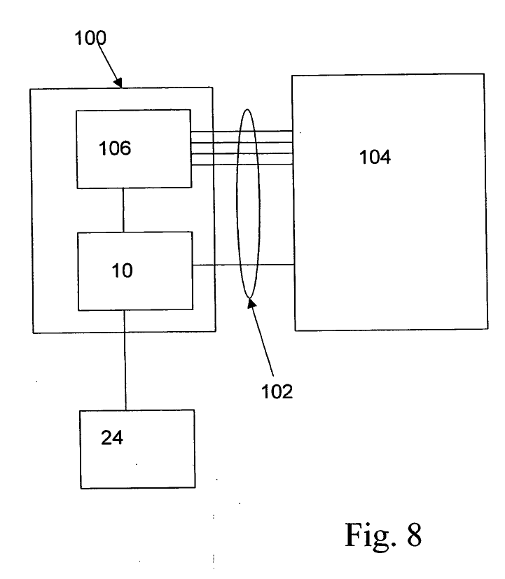

In practice, the implementations achieved through use of the present real-time processor 10 apply to equipment tested by interfacing with signals that must accurately emulate timing critical functions. For example, and with reference to FIG. 8, the Launch Station Test Set 100 uses the present real-time processor 10 to emulate a control system and missiles to step the missile launcher 102 through a simulated launch with time critical issue. When implementing the Launch Station Test Set 100, control system and missile launcher interface 102 actions are emulated by the present real-time processor 10 in order to test the missile launcher's response to command stimuli. Further, the present real-time processor 10 is used to control a missile simulator 106. Test sequences (executable programs) are stored on a PC 24, and transferred to the memory 15 in the real-time processor 10. The missile simulator 106 interface is used to verify that the launcher 104 executes launches and other functions properly. The missile simulator 106 and control system interfaces 102 are extremely dependent on signal timing and must be implemented with appropriate timing accuracy in order to properly test the launcher interfaces.

An example of an instruction set for use in conjunction with the Launch Station Test Set is present below. In this example the following instructions apply:
STP—Standard Test Procedure, STPs are tracked to help create error codes.
CABLE—a single event output that changes a cable connection.
DSO—Diagnostic Scanner Output, a single event output with a register address and 8-bit data
DSI—Diagnostic Scanner Input, a single event input with register address, expected data, data mask, and failure processing information.
ADC—Analog to Digital Converter input, a single event input whose data is derived from an analog to digital converter. This instruction includes information on the source signal to be measured, low and high value limits, and failure processing information.
LAM—a combination of serial output and input command. This instruction specifies the message to be sent, the message to be received, and failure processing information. The timing of the received message is implied in the command (fixed).

#—comment delimiter.

| SEQUENCE DataAcquisitionTest | | |
|---|---|---|
| STP 0 | | |
| CABLE 8 | | |
| | # | Testing in reference to J3 |
| OLDSTP 13 | | |
| Clock 0 | | |
| DSO 056, 0 | # | Clear MDC |

| DSI 0, 0, 0 | | |
|---|---|---|
| DSI 001, 0, 0 | | |
| DSI 053, 0X7000, 0XF000, 06, 0, # Check that Active Cable was set | | |
| DSO 051, 0x00DC | | |
| ADC 0x00DC, 0xE70, 0xFFF, 06, # Check +12V Power | | |
| DSO 051, 0x00E0 | | |
| ADC 0x00E0, 0xE70, 0xFFF, 06, # Check −12V Power | | |
| DSO 051, 0x00EC | | |
| ADC 0x00EC, 0x6E0, 0x868, 06, # Check +5V Power | | |
| DSO 051, 0x00F0 | | |
| ADC 0x00F0, 0x498, 0x583, 06, # Check +3.3V Power | | |
| DSO 051, 0x00FC | | |
| ADC 0x00FC, 0x370, 0x43C, 06, # Check +2.5V Power | | |
| Clock 50 | | |
| DSI 002, 0, 0 | | |
| Clock 100 | | |
| DSI 003, 0, 0 | | |
| Clock 150 | | |
| DSI 1, 0, 0 | | |
| DSI 053, 06200, 07200, 05, 150, | | |
| Clock 200 | | |
| DSI 0, 0, 0 | | |
| Clock 250 | | |
| DSI 053, 0X7000, 0XF000, 06, 250, # Check that Active Cable was set | | |
| Clock 300 | | |
| DSI 0, 0, 0 | | |
| ENDSTP # 0 | | |
| STP 1 | | |
| CABLE 1 | | |
| Clock 0 | | |
| DSO 056, 0 | # | Clear MDC |

| DSI 053, 0XE000, 0XF000, 06, 0, # Check that Active Cable was set | | |
|---|---|---|
| Clock 50 | | |
| DSI 002, 0, 0 | | |
| Clock 100 | | |
| DSI 003, 0, 0 | | |
| Clock 150 | | |
| DSI 053, 06200, 07200, 05, 150, | | |
| Clock 200 | | |
| DSI 0, 0, 0 | | |
| Clock 250 | | |
| DSI 053, 0XE000, 0XF000, 06, 250, # Check that Active Cable was set | | |
| Clock 300 | | |
| DSI 0, 0, 0 | | |
| ENDSTP # 1 | | |
| STP 2 | | |
| CABLE 2 | | |
| Clock 0 | | |
| DSO 056, 0 | # | Clear MDC |
| DSI 053, 0XD000, 0XF000, 06, 0, # Check that Active Cable was set | | |
| Clock 50 | | |
| DSI 002, 0, 0 | | |
| Clock 100 | | |
| DSI 003, 0, 0 | | |
| Clock 150 | | |
| DSI 053, 06200, 07200, 05, 150, | | |
| Clock 200 | | |
| DSI 0, 0, 0 | | |
| Clock 250 | | |
| DSI 053, 0XD000, 0XF000, 06, 250, # Check that Active Cable was set | | |
| Clock 300 | | |
| DSI 0, 0, 0 | | |
| ENDSTP # 2 | | |
| STP 3 | | |
| CABLE 4 | | |
| Clock 0 | | |
| DSO 056, 0 | # | Clear MDC |

| DSI 053, 0XB000, 0XF000, 06, 0, # Check that Active Cable was set | | |
|---|---|---|
| Clock 50 | | |
| DSI 002, 0, 0 | | |
| Clock 100 | | |
| DSI 003, 0, 0 | | |
| Clock 150 | | |
| DSI 053, 06200, 07200, 05, 150, | | |
| Clock 200 | | |
| DSI 0, 0, 0 | | |
| Clock 250 | | |
| DSI 053, 0XB000, 0XF000, 06, 250, | | |
| Clock 300 | | |
| DSI 0, 0, 0 | | |
| ENDSTP # 3 | | |
| ENDBLOCK # DataAcquisitionTest | | |
| Sequence Test2BiteGM | | |
| STP 2 | | |
| OLDSTP 012 | | |
| CABLE 4 | | |
| # STP(012, 000, 007) | | |
| Clock 0 | | |
| # SCM(014, 0000) | | |
| # CRM(052, 011, 0000) | | |
| LAM 011, (014), (0x88888888, 0x2222222, 0x11111111) | | |
| DSO 034, 0 # Clear LF | | |
| DSO 035, 0377 | | # Connect all 4 rnds, Bite UL CMD |
| DSI 021, 0115000, 0177017, 05 | | |
| Clock 1 | # | MRT 7 |

| | |
|---|---|
| DSO 051, 0103074 | # MRT 7 |

| Clock 2 | |
|---|---|
| DSI 021, 0140003, 0174017, 05 # Select mode and In Lch | |
| DSO 035, 017 | # Disc Relays to neutral |

| Clock 8 | |
|---|---|
| DSI 022, 02341, 077777, 05 | |
| DSI 020, 0, 04000, 034 | |
| DSO 052, 011 | |
| Clock 9 | |
| DSO 052, 051 | |
| DSI 021, 0, 0200, 05 | # Msl Present |
| Clock 10 | |
| DSI 020, 0, 04000, 035 | |
| Clock 11 | |
| DSI 021, 0, 017, 05 | |
| DSI 022, 0, 1, 05 | # UL Rly Cmd Removed |

| | |
|---|---|
| Clock 30 | # MRT 7 |

| | |
|---|---|
| DSO 051, 0103075 | # MRT 7 |
| DSO 052, 011 | # BITEGM timeline |

| Clock 31 | |
|---|---|
| DSO 034, 0 | # Clear LF |
| Clock 40 | |
| # SCM(015, 0040) | |
| # CRM(053, 011, 0040) | |
| LAM 011, (015), (0x88888888, 0x77777777, 0x33333333) | |
| Clock 41 | |
| DSI 021, 0140003, 0174017, 05 | |
| Clock 48 | |
| DSI 022, 02322, 077777, 05 | |
| DSI 020, 0, 04000, 034 | |
| Clock 49 | |
| DSO 052, 051 | # |

| | |
|---|---|
| DSI 021, 0, 0200, 05 | # Msl Present |

| Clock 50 | |
|---|---|
| DSI 020, 0, 04000, 035 | |
| Clock 51 | |
| DSI 021, 0, 017, 05 | |
| DSI 022, 0, 02, 05 | # UR Rly Cmd Removed |

| | |
|---|---|
| Clock 70 | # MRT 7 |

| | |
|---|---|
| DSO 051, 0103076 | # MRT 7 |
| DSO 052, 011 | # BITEGM timeline |

| | |
|---|---|
| Clock 71 | # |
| DSO 034, 0 | # Clear LF |

| Clock 80 | |
|---|---|
| # SCM(016, 0080) | |
| # CRM(054, 011, 0080) | |
| LAM 011, (016), (0x8888888, 0x11111111, 0X22222222) | |
| Clock 81 | |
| DSI 021, 0140003, 0174017, 05 # Bite LL Cmd | |
| Clock 88 | |
| DSI 022, 02264, 077777, 05 | |
| DSI 020, 0, 04000, 034 | |
| Clock 89 | |
| DSI 021, 0, 0200, 05 | # Msl Present |
| DSO 052, 051 | # Added Jun. 4, 2001 to conform to BYTE GM timeline |

| Clock 90 | |
|---|---|
| DSI 020, 0, 04000, 035 | |
| Clock 91 | |
| DSI 021, 0, 017, 05 | |
| DSI 022, 0, 04, 05 | # LL Cmd Removed |

| | |
|---|---|
| Clock 110 | # MRT 7 |

| DSO 051, 0103077 | # MRT 7 | |
|---|---|---|
| DSO 052, 011 | # | Jun. 4, 2001 for BITEGM timeline |

| | |
|---|---|
| Clock 111 | # added for test, May 8, 2001 jml |
| DSO 034, 0 | # Clear LF |

| Clock 120 | |
|---|---|
| # SCM(017, 0120) | |
| # CRM(055, 011, 0120) | |
| LAM 011, (017), (0xFDFDFDFD, 0XA0A0A0A0, 0X1E1E1E1E) | |
| Clock 121 | |
| DSI 021, 0140003, 0174017, 05 # Bite LR Cmd | |
| Clock 128 | |
| DSI 022, 02170, 077777, 05 | |
| DSI 020, 0, 04000, 034 | |
| Clock 129 | |
| DSO 052, 051 | # Added Jun. 4, 2001 to conform to BYTE GM timeline |

| DSI 021, 0, 0200, 05 | |
|---|---|
| Clock 130 | |
| DSI 020, 0, 04000, 035 | |
| Clock 131 | |
| DSI 021, 0, 017, 05 | |
| DSI 022, 0, 010, 05 | |
| Clock 132 | |
| DSO 034, 0 # Clear LF | |
| ENDSTP # 2 | |
| EndBlock | #Test2BiteGM |

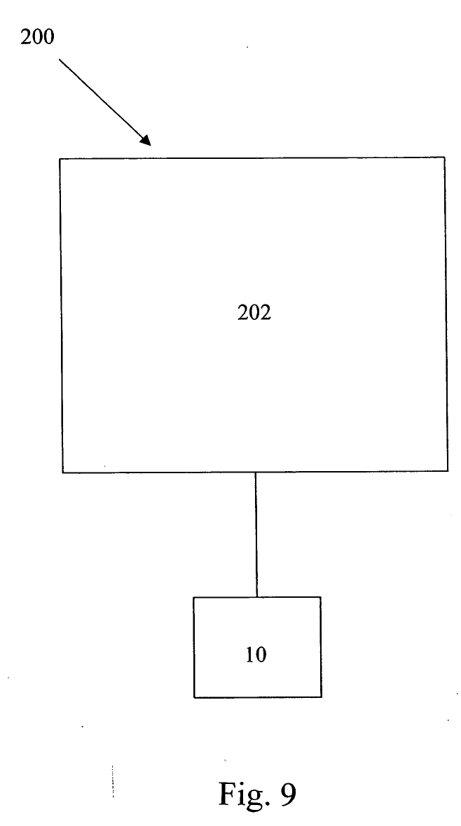

A second embodiment employs the real time processor 10 in an Engagement Control System—Factory Test Emulator 200 (see FIG. 9). The Engagement Control System—Factory Test Emulator 200 emulates precision signals issued over a serial data link. The signals and serial data link are synchronized due to serial messages such that the missiles are synchronized with messages to operate in tandem. More specifically, the system is designed to emulate the fiber optic portion of the Engagement Control System to the launching system software. The Engagement Control System—Factory Test Emulator 200 performs pre-written test sequences that are composed of Launcher Action Messages (LAM) and synchronization messages that are transmitted to the launching system 202 via fiber optic link. The Engagement Control System test sequences evaluate the timing and content of the launching system 202 responses to the LAMs. The Engagement Control System—Factory Test Emulator 200 can also send single LAMs on operator command for detailed testing and evaluation.

In accordance with preferred embodiments of the systems discussed above, the Launch Station Test Set 100 uses 10-millisecond timing for the clock counter 12 and the Engagement Control System—Factory Test Emulator 200 uses 1-millisecond timing for the clock counter 12.

While those skilled in the art will appreciate that various functions and instructions may be employed in accordance with the present invention, the following presents an overview allowing for implementation of the present real-time processor:

The ECS Sequencer has LAM/LRM (Launcher Response Message) Capability. All Sequences begin execution at Address 0x0.

I. Function Types—each of these functions can be executed at a specified time during a test sequence.

| | | |
|---|---|---|
| CLOCK | (B“11110”) | |
| DELAY | (B“11111”) | |
| WRITE Clock | (B“11100”) | Writes the Clock Counter 12 |
| WRITE Address | (B“11010”) | Write a value to the Sequencer Address |
| | | Register |
| WRITE Loop | (B“11000”) | Write a value to the Loop Counter/ |
| | | Register |
| WRITE LogStart | (B“10110”) | Write to the “Start of Log File” Address |
| | | Register |
| LRM | (B“10100”) | LRM Sequencer and LRM Correlator |
| | | actions |
| Unused | (B“10010”) | |
| PTT_ON | (B“10001”) | |
| PTT_OFF | (B“10000”) | |
| READ Loop | (B“01110”) | Read, Decrement, and compare Loop |
| | | Counter |
| READ Status | (B“01100”) | Read and compare Status register |
| CLR Status | (B“01010”) | Clears Status register |
| END | (B“01000”) | Sequencer Stops, set |
| | | ECS_Sequence_Active low |
| LAMD | (B“00111”) | Dual LAM |
| LAMS | (B“00110”) | Single LAM and Sync Message |
| REPORT | (B“00010”) | |
| Data Word | (B“00000”) | |

II. Registers
   Global Status Register—memory address 0x0001.
      bit 0—reserved
      bit 1—ECS Sequencer Operating Status
      bit 2—reserved for PAC2 Sequencer Operating Status
   ECS Sequencer Control—Write only from PC. Writing 1 causes ECS Sequence to begin execution of a Test Sequence; Writing 0 causes ECS Sequencer to cease execution of Test Sequence. Condition of this register is reflected by the value in bit 1 of the Global Status Register. Memory address 0x0400
   ECS Sequencer Clock—ECS Test Time Counter register. 28-bit, 1 millisecond counter. May be changed to 100 microsecond counter in future versions. Memory address 0x0401.
   ECS Sequencer Address—the memory address of the next instruction (or function) to execute. Memory address 0x0402
   ECS Loop Counter—Count-down counter used to realize sequence loops. Decrements with each READ Loop command. The READ Loop command branches whenever the Loop Counter register is non-zero. Memory address 0x0403
   ECS Sequencer Status—Contains sequencer status information. Memory address 0x0404
      bit 0—reserved
      bit 1—RF LRM received, set by the RF correlator
      bit 2—FO LRM received, set by the FO correlator
      bit 3—reserved
      bit 4—Valid LRM received, any LRM received should set this bit and either the FO LRM bit or the RF LRM bit. Set by either correlator.
      bit 5—reserved
      bit 6—Missing LRM, set by the Sequencer when a LRM function reaches its time limit without receiving a LRM from a correlator.
      bit 7—ECS Loop error, indicates that the Loop Counter was 0 before being decremented by a READ Loop function.
      bit 8—ECS Sequencer error, indicates an illegal value in the most significant nibble of a word fetched from ECS Sequencer memory or in the case of an illegal branch address. Bit is set to 1 if a word is expected to be a function opcode but begins with either 0x0 or 0x9, or if a word is expected to be data (Data words of LRM or READ Status) and does not begin with 0x0. Bit is also set if a branch address greater than or equal to the LogStart value.
      bit 9—reserved
      bit 10—reserved
      bit 11—reserved
      bit 12—Sequence termination by PC command
      bit 13—Sequence termination by memory overflow
      bit 14—Sequence termination by END function
      bit 15—Sequence termination by Sequence error
      bit 16—Memory status bit 1 (1 indicates 1 M of memory full)
      bit 17—Memory status bit 2 (1 indicates 2M of memory full)
      bit 18—Memory status bit 3 (1 indicates 3M of memory full)
      bit 19—Memory status bit 4 (1 indicates 4M of memory full, completely full)
   ECS Sequencer LogStart—Contains the memory address of the first Log Data word. Memory address 0x0405
   ECS Sequencer LogEnd—Contains the memory address of the last Log Data word. Memory address 0x0406
III. Functions
   A. CLOCK—Specified Time—When a test sequence starts the Test Time is set to zero and begins incrementing in milliseconds.
      Clock Function Rules:
         The Test Time clock is set to zero AFTER any preliminary functions are completed.
         The Test Time begins incrementing synchronized to the first IRIG-B PPS rising edge after preliminary functions are completed.
         Once the Test Time clock begins running, it remains synchronized to its own 1 millisecond clock and does not re-synchronize.
         If there is no function to execute at a particular time, no CLOCK command is used. If a CLOCK command is used at a particular time, a function MUST follow after the CLOCK command.
         The Command Word CLOCK delineates actions that occur at the Test Time Specified.
         Clock can be reset by invoking the WRITE Clock Function. The WRITE Clock function does not re-synchronize the Test Time clock.

28-bit 1 millisecond counter allows a 74 hour test with no loops (clock resets).

CLOCK Function Mnemonic

| Bits 31-27 | Bits 27-0 |
|---|---|
| 11110 | Test Time in milliseconds |

Test Script Example:

| CLOCK 0 | [mnemonic 0xF0000000] |
|---|---|
| READ 0x00010000, MASK 0x00000001, XDATA 0x00000001, | |
| BRANCH 0x01000000 | |
| READ 0x00010002, MASK 0x00007001, XDATA 0x00004000, | |
| BRANCH 0x01000000 | |
| WRITE 0x00020001, DATA 0x0000AF01 | |
| CLOCK 600 | [mnemonic 0xF0000258] |
| PTT ON | |
| CLOCK 1000 | [mnemonic 0xF00003E8] |
| LAMS, 0x901901, 0x04, 0x080 | |
| CLOCK 1400 | [mnemonic 0xF0000578] |

PTT OFF

In the example above:
   1. The READ and WRITE operations after CLOCK 0, take place sequentially (as fast as possible).
   2. Nothing happens after the WRITE operation until time 600 (based on the next CLOCK command.
   3. At time 600, the PTT ON command is issued.
   4. Nothing happens until time 1000 (one second).
   5. At time 1000, a Single LAM is sent.
   6. Nothing happens until Test Time 1400.
   7. At Time 1400 the PTT OFF command is issued.

B. WRITE Clock—allows a specific time to be written to the ECS Test Time Counter register so that a branch allows timing to continue operating correctly.

WRITE Clock Function Mnemonic

| Bits 31-27 | Bits 26-0 |
|---|---|
| 11100 | Test Time in milliseconds |

Test Script Example:
WRITE Clock 100 [mnemonic 0xE0000064]
The above example writes a decimal 100 (0x064) to the clock register. This is primarily used in association with the WRITE Address command.

C. DELAY—Causes a specified delay.

| Bits 31-27 | Bits 26-0 |
|---|---|
| 11111 | Delay value in milliseconds |

When executed, the DELAY instruction will cause Sequencer execution to suspend for the specified duration of time (in addition to the time remaining in the present, one-millisecond period). It should be further understood that external events are asynchronous and, when received into the system and registered or synchronized by the system, will always have an uncertainty of between 0 and 1 time periods. It is contemplated future implementations of the Delay instruction will determine in which half of the time period the instruction was executed and automatically adjust the delay by adding either 0 or 1 time period thereby always achieving the exact, specified delay in a repeatable fashion.

Test Script Example, occurring at Test Time 5-milliseconds:

DELAY 100 # [mnemonic 0xF8000064]

In the test script example, the DELAY instruction was encountered during the 5-millisecond period of sequence execution, and therefore delayed until the present 5-millisecond Test Time period ended.
It then caused the specified 100 millisecond delay to occur from the beginning of Test Time period 6-milliseconds to the beginning of Test Time period 106-milliseconds, resulting in an exact 100 millisecond delay (in addition to the time that was remaining in the one-millisecond time period when the DELAY instruction was originally encountered).

D. WRITEADDRESS—Changes the value of the Sequencer Address Register. This causes Sequencer execution to unconditionally continue at the specified address, which can be a label or a hex value in the Sequencer's address space (not global address space).

WRITEADDRESS Function Mnemonic

| Bits 31-27 | Bits 26-24 | Bits 23-0 |
|---|---|---|
| 11010 | 000 | Address of next Function to execute |

Test Script Example using hex value:

| | |
|---|---|
| WRITEADDRESS 0x100 | # [mnemonic 0xD0000100] |

Test Script Example using label:

| | |
|---|---|
| WRITEADDRESS LOOP1 | # [mnemonic 0xD0000000+address of PTT |
| instruction] | |
| | : |
| LOOP 1: | |
| | PTT ON |
| | : |

The first example writes the hexadecimal value 0x100 to the Address Register, causing execution to branch to 0x100 where the next instruction is stored.
The second example uses a label to branch to the address of the PTT ON instruction.

E. WRITE Loop—changes the value of the Loop Counter Register.

WRITE Loop Function Mnemonic

| Bits 31-27 | Bits 26-0 |
|---|---|
| 11000 | Loop Value |

Test Script Example:
WRITE Address 10,000 [mnemonic 0xC0002710]
This example write the decimal value 10,000 (0x2710) to the Address register.

Using the WRITE Loop function to write a zero to the Loop Register is considered an illegal action and should be prohibited by the Sequence Compiler.

WRITE LogStart Function Mnemonic

| Bits 31-27 | Bits 26-0 |
|---|---|
| 10110 | Memory Address of the start of test log |
| | information |

This function is not used in the Test Sequence, but is user by the Test Sequence Compiler. The WRITE LogStart function MUST be the first entry in the compiled sequence to ensure that the sequencer does not start writing log data to an unknown location.
F. LRM—Sets the LRM receiver/correlator to receive a LRM Message.
   This will also be an indirectly addressed function. The command word becomes the mnemonic+the address of the data.

The LRM Function explicitly expects either an RF or FO LRM. This is determined by the RF/FO bit in Data Word 8. If RF/FO=0, the expected LRM is FO; If RF/FO=1, the expected LRM is RF.

| Command Word | 0xA0aa, aaaa | 8 MSb = 0xA0 + 24 bit Data Address |
|---|---|---|
| Data Word 1 | 0x00xx, xxxx | 8 MSb = 0x0 + 24 bit Branch |
| | | Address |
| Data Word 2 | 0x00yy, yyyy | 8 MSb = 0x0 + 24 bit Mask for |
| | | LRM word 1 |
| Data Word 3 | 0x00zz, zzzz | 8 MSb = 0x0 + 24 bit Mask for |
| | | LRM word 2 |
| Data Word 4 | 0x00qq, qqqq | 8 MSb = 0x0 + 24 bit Mask for |
| | | LRM word 3 |
| Data Word 5 | 0x00rr, rrrr | 8 MSb = 0x0 + 24 bit Data for |
| | | LRM word 1 |
| Data Word 6 | 0x00ss, ssss | 8 MSb = 0x0 + 24 bit Data for |
| | | LRM word 2 |
| Data Word 7 | 0x00tt, tttt | 8 MSb = 0x0 + 24 bit Data for |
| | | LRM word 3 |
| Data Word 8 | 0x0r00, 00dd | 4 MSb = 0x0 + RF/FO |
| | | information + 8 bit delay value |

The LRM Function provides the mask bits and the data bits for the three expected words of the LRM. If a mask bit=1 (in words 1-3), the respective LRM bit is compared to its respective data bit (in words 4-6). If the mask bit=0, no comparison is made. If all comparisons match, the LRM reception passes and no branch is executed. If the comparisons fails, the Address register is written with the address represented in Word 7 and the sequencer begins executing the instruction stored at that address.
The LRM function causes a LRM received bit to be set in the status register and also sets either a FO_LRM_bit or an RF_LRM_bit.
LRM Rules:
1. The correlator is always active.
2. The LRM function expects data from the correlator.
3. The LRM function remains active until a LRM is received and time-stamped or until a predetermined time has elapsed. If no LRM is received before the time elapses, a failure status is reported and a failure to receive is logged.
The entire LRM (all data) is logged along with the time of reception (both Test Time and UTC) and status information (LRM matched expected data, RF or FO LRM).

G. PTT—outputs the RF Push To Talk function. Writing a 1 to this register activates PTT, writing 0 de-activates PTT.

PTT Function Mnemonic

| Bits 31-27 | Bits 27-1 | Bit 0 |
|---|---|---|
| 0x8 | Don't Care | PTT Value |

Test Script Example:

| | |
|---|---|
| PTT ON | [mnemonic 0x88000001] |
| PTT OFF | [mnemonic 0x80000000] |

H. READ Loop—Checks the Loop register for a zero value. A non-zero value is considered a “BRANCH on FAIL” condition causing the function to load the Address register with the value stored in the data bits and forcing the sequencer to begin execution at the indicated address. When a READ Loop is executed, the Loop register is automatically decremented.

READ Loop Function Mnemonic

| Bits 31-27 | Bits 26-0 |
|---|---|
| 01110 | Branch Address |

Test Script Example:
READ Loop 0x0123 [mnemonic 0x70000123]

H. READ Status—Checks the Status register for a predetermined value.

| | | |
|---|---|---|
| Word 1 | 0x60xx, xxxx | 4 MSB = 0xA + Branch Address |
| Word 2 | 0x00yy, yyyy | 4 MSB = 0x0 + 24 bit Expected Data |
| Word 3 | 0x00zz, zzzz | 4 MSB = 0x0 + 24 bit Mask |

Test Script Example:

READ Status Branch Blue_label, Data 0x012, MASK 0x0FF
READ Status Branch 0x120, Data 0x012, MASK 0x0FF
[word 1 = 0x70000120, word 2 = 0x012, word 3 = 0x00FF]

I. CLR Status—Clears the status register so that no status data may be checked.

CLR Status Function Mnemonic

| Bits 31-27 | Bits 26-0 |
|---|---|
| 01010 | 0 |

Test Script Example:
CLR Status [mnemonic 0x50000000]

J. END—Stops sequencer execution. Clears ECS_Sequencer_Active signal.

END Function Mnemonic

| Bits 31-27 | Bits 26-0 |
|---|---|
| 010000 | 0 |

Test Script Example:
END [mnemonic 0x40000000]

K. LAMD—Dual LAM. The LAM functions utilize indirect addressing to simplify implementation. Because of this, the mnemonic does not represent the instruction. All of the data sent by the LAM generator is stored at the address specified in the mnemonic. The complete LAM (with the exception of the FO “time of day” word) is generated by the software residing on the PC.

LAMD Function Mnemonic

| Bits 31-27 | Bits 26-0 |
|---|---|
| 00111 | Starting Address of LAM Data |

Test Script Example:
LAMD
0x92F92F 0x000004 0xA3EAEE
0x91F91F 0x000004 0xA3EAEE
CORRUPT R10 0xFF7653 F8 0x101011
1^{st} 3 words represent the 1^{st} LAM; the Data Words without the Error Check word.
2^{nd} 3 words represent the 2^{nd} LAM; the Data Words without the Error Check word
   The CORRUPT string denotes that corruption data will follow
Corruption data does not have to be present
The R10 means; RF LAM, change the 10^{th} word to the following word (0xFF7653)
The F8 means; Fiber Optic LAM, change the 8^{th} word to the following word (0x101011)
The LAM Data is made up of 64 words of RF data and 11 words of FO data

L. LAMS—Single LAM. The LAM functions utilize indirect addressing to simplify implementation. Because of this, the mnemonic does not represent the instruction. The detailed LAM data is stored at the address specified in the mnemonic.

LAMS Function Mnemonic

| Bits 31-27 | Bits 26-0 |
|---|---|
| 00110 | Starting Address of LAM Data |

Test Script Example:
LAMS 0x801801, 0x040, 0x08, [mnemonic 0x20002000]
CORRUPT R10 0xFF7653 F8 0x101011

M. REPORT—Sends a predefined message word back to the PC.

REPORT Function Mnemonic

| Bits 31-27 | Bits 26-0 |
|---|---|
| 00010 | Report Data |

Test Script Example:
REPORT 0x0103 [mnemonic 0x10000103]

N. Data Word—All Data words in each function begin with a zero nibble. A word with a non-zero Most Significant Nibble, indicates a Function word.

User Level Program Example

```
WriteLoop 10  # Set up basic loop X10
CLOCK 0
    READstatus BRANCH LABEL4 XDATA 0X01 MASK 0X01
    PTT ON
    CLR STATUS
    REPORT 1
LABEL1:
CLOCK 2
    PTT OFF
CLOCK 100  # Send Dummy LAM
    LAMS 0X888888 0X888888 0X0
    PTT ON
CLOCK 102
    PTT OFF
CLOCK 900
    SYNC 0x333333 0x555555 0x444444
    PTT ON
CLOCK 902
    PTT OFF
CLOCK 1600
    PTT ON
CLOCK 1601
    WRITEclock 1
    READloop LABEL1
#
# BITE GM LL
#
#
CLOCK 2
    PTT OFF
CLOCK 100  # Send LAM, BITE GMUL
    LAMS 0X111111 0X121212 0X333333
    PTT ON
CLOCK 102
    PTT OFF
CLOCK 590
    LRM MASK 0xFFF000 0x0 0x0
    XDATA 0x111000 0x0 0x0 FO 100 BRANCH
      LRM_Failed
# Checks LRM ID Only, Fiber Optic LRM, Receive delay of 100 mS
CLOCK 700
    READstatus BRANCH LABEL3 XDATA 0X015 MASK 0X0FF
CLOCK 701
    REPORT 4 “BITE GMLL LRM Received”
CLOCK 900
    SYNC 0x111111 0x222222 0x333333
    PTT ON
CLOCK 902
    PTT OFF
CLOCK 1600
    PTT ON
CLOCK 1601
    WRITEclock 1
####################
LABEL2:
CLOCK 2
    PTT OFF
CLOCK 100  # Send Dummy LAM
    LAMS 0XAAAAAA 0x111111 0X0
    PTT ON
CLOCK 102
    PTT OFF
CLOCK 900
    SYNC 0x111111 0x121212 0x444444
    PTT ON
CLOCK 902
    PTT OFF
CLOCK 1600
    PTT ON
CLOCK 1601
    WRITEclock 1
    READloop LABEL2
CLOCK 10
    PTT OFF
CLOCK 20  # Double PTT Indicates END OF TEST
    PTT ON
CLOCK 30
    PTT OFF
    END
LABEL3:
    REPORT 2  # “LRM Status Failed”
    END
LABEL 4:
    REPORT 1  # “Beginning Status Failed”
    END
LRM_Failed:
    READstatus BRANCH dummy XDATA 0X01 MASK 0XFF
    dummy:
    REPORT 10  # “BITE GMLL LRM Failed”
    END
```

Mid-Level Script (Compiler listing)

| Address | Value | Line# | Source Line |
|---|---|---|---|
| 00000000 | B0000091 | 0 | WRITELOGSTART 0X000091 |
| | | 9 | |
| 00000001 | C000000A | 10 | WriteLoop 10 # Set up basic loop X10 |
| | | 11 | |
| | | 12 | |
| 00000002 | F0000000 | 13 | CLOCK 0 |
| 00000003 | 6000004D | 14 | READstatus BRANCH LABEL4 XDATA 0X01 MASK 0X01 |
| 00000004 | 80000001 | 15 | PTT ON |
| 00000005 | 50000000 | 16 | CLR STATUS |
| 00000006 | 1000002C | 17 | REPORT 44 |
| | | 18 | |
| | | 19 | LABEL1 |
| 00000007 | F0000002 | 20 | CLOCK 2 |
| 00000008 | 80000000 | 21 | PTT OFF |
| | | 22 | |
| 00000009 | F0000064 | 23 | CLOCK 100 # Send Dummy LAM |
| 0000000A | 20000050 | 24 | LAMS 0x111111 0x888888 0x888888 0x0 0xBBBBBB |
| | | | 0x888888 0x888888 0x0 0xBBBBBB 0x888888 0x888888 |
| | | | 0x0 0xBBBBBB 0x0 |
| 0000000B | 80000001 | 25 | PTT ON |
| | | 26 | |
| 0000000C | F0000066 | 27 | CLOCK 102 |
| 0000000D | 80000000 | 28 | PTT OFF |
| | | 29 | |
| | | 30 | |
| 0000000E | F0000384 | 31 | CLOCK 900 |
| 0000000F | 9000005E | 32 | SYNC 0x333333 0x555555 0x444444 |
| 00000010 | 80000001 | 33 | PTT ON |
| | | 34 | |
| 00000011 | F0000386 | 35 | CLOCK 902 |
| 00000012 | 80000000 | 36 | PTT OFF |
| | | 37 | |
| | | 38 | |
| 00000013 | F0000640 | 39 | CLOCK 1600 |
| 00000014 | 80000001 | 40 | PTT ON |
| | | 41 | |
| 00000015 | F0000641 | 42 | CLOCK 1601 |
| 00000016 | E0000001 | 43 | WRITEclock 1 |
| 00000017 | 70000007 | 44 | READloop LABEL1 |
| | | 45 | |
| | | 46 | # |
| | | 47 | # |
| | | 48 | # BITE GM LL |
| | | 49 | # |
| | | 50 | # |
| | | 51 | |
| 00000018 | F0000002 | 52 | CLOCK 2 |
| 00000019 | 80000000 | 53 | PTT OFF |
| | | 54 | |
| 0000001A | F0000064 | 55 | CLOCK 100 # Send LAM, BITE GMLR, LBID = A, LS = 1 |
| 0000001B | 20000061 | 56 | LAMS 0x111111 0x111111 0x121212 0x333333 0xABABAB |
| | | | 0x111111 0x121212 0x333333 0xABABAB 0x111111 |
| | | | 0x121212 0x333333 0xABABAB 0x0 |
| 0000001C | 80000001 | 57 | PTT ON |
| | | 58 | |
| 0000001D | F0000066 | 59 | CLOCK 102 |
| 0000001E | 80000000 | 60 | PTT OFF |
| | | 61 | |
| 0000001F | F000024E | 62 | CLOCK 590 |
| 00000020 | A000006F | 63 | LRM MASK 0xFFF000 0x0 0x0 XDATA 0x111000 0x0 0x0 |
| | | | FO 100 BRANCH LRM_Failed |
| | | 64 | # Checks LRM ID Only, Fiber Optic LRM, |
| | | | Receive delay of 100 mS |
| | | 65 | |
| 00000021 | F00002BC | 66 | CLOCK 700 |
| 00000022 | 60000077 | 67 | READstatus BRANCH LABEL3 XDATA 0X015 MASK 0X0FF |
| | | 68 | |
| 00000023 | F00002BD | 69 | CLOCK 701 |
| 00000024 | 10000004 | 70 | REPORT 4 # “BITE GMLR LRM Received” |
| | | 71 | |
| 00000025 | F0000384 | 72 | CLOCK 900 |
| 00000026 | 9000007A | 73 | SYNC 0x111111 0x222222 0x333333 |
| 00000027 | 80000001 | 74 | PTT ON |
| | | 75 | |
| 00000028 | F0000386 | 76 | CLOCK 902 |
| 00000029 | 80000000 | 77 | PTT OFF |
| | | 78 | |
| | | 79 | |
| 0000002A | F0000640 | 80 | CLOCK 1600 |
| 0000002B | 80000001 | 81 | PTT ON |
| | | 82 | |
| 0000002C | F0000641 | 83 | CLOCK 1601 |
| 0000002D | E0000001 | 84 | WRITEclock 1 |
| | | 85 | #################### |
| | | 86 | |
| | | 87 | |
| | | 88 | LABEL2 |
| 0000002E | F0000002 | 89 | CLOCK 2 |
| 0000002F | 80000000 | 90 | PTT OFF |
| | | 91 | |
| 00000030 | F0000064 | 92 | CLOCK 100 # Send Dummy LAM |
| 00000031 | 2000007D | 93 | LAMS 0x111111 0xAAAAAA 0x111111 0x0 0x777777 |
| | | | 0xAAAAAA 0x111111 0x0 0x777777 0xAAAAAA 0x111111 |
| | | | 0x0 0x777777 0x0 |
| 00000032 | 80000001 | 94 | PTT ON |
| | | 95 | |
| 00000033 | F0000066 | 96 | CLOCK 102 |
| 00000034 | 80000000 | 97 | PTT OFF |
| | | 98 | |
| | | 99 | |
| 00000035 | F0000384 | 100 | CLOCK 900 |
| 00000036 | 9000008B | 101 | SYNC 0x111111 0x121212 0x444444 |
| 00000037 | 80000001 | 102 | PTT ON |
| | | 103 | |
| 00000038 | F0000386 | 104 | CLOCK 902 |
| 00000039 | 80000000 | 105 | PTT OFF |
| | | 106 | |
| | | 107 | |
| 0000003A | F0000640 | 108 | CLOCK 1600 |
| 0000003B | 80000001 | 109 | PTT ON |
| | | 110 | |
| 0000003C | F0000641 | 111 | CLOCK 1601 |
| 0000003D | E0000001 | 112 | WRITEclock 1 |
| 0000003E | 7000002E | 113 | READloop LABEL2 |
| | | 114 | |
| 0000003F | F000000A | 115 | CLOCK 10 |
| 00000040 | 80000000 | 116 | PTT OFF |
| | | 117 | |
| 00000041 | F0000014 | 118 | CLOCK 20 # Double PTT Indicates END OF TEST |
| 00000042 | 80000001 | 119 | PTT ON |
| | | 120 | |
| 00000043 | F000001E | 121 | CLOCK 30 |
| 00000044 | 80000000 | 122 | PTT OFF |
| 00000045 | 40000000 | 123 | END |
| | | 124 | |
| | | 125 | |
| | | 126 | LABEL3 |
| 00000046 | 10000002 | 127 | REPORT 2 # “LRM Status Failed” |
| 00000047 | 40000000 | 128 | END |
| | | 129 | |
| | | 130 | |
| | | 131 | LABEL4 |
| 00000048 | 10000001 | 132 | REPORT 1 # “Beginning Status Failed” |
| 00000049 | 40000000 | 133 | END |
| | | 134 | |
| | | 135 | LRM_Failed |
| 0000004A | 6000008E | 136 | READstatus BRANCH dummy XDATA 0X01 MASK 0XFF |
| | | 137 | dummy |
| 0000004B | 1000000A | 138 | REPORT 10 # “BITE GMLL LRM Failed” |
| 0000004C | 40000000 | 139 | END |

Generated Data Blocks

| Address | Count | Values | | | | | |
|---|---|---|---|---|---|---|---|
| 0000004D | 3 | 00000048 | 00000001 | 00000001 | | | |
| 00000050 | 14 | 00111111 | 00888888 | 00888888 | 00000000 | 00BBBBBB | 00888888 |
| | | 00888888 | 00000000 | 00BBBBBB | 00888888 | 00888888 | 00000000 |
| | | 00BBBBBB | 00000000 | | | | |
| 0000005E | 3 | 00333333 | 00555555 | 00444444 | | | |
| 00000061 | 14 | 00111111 | 00111111 | 00121212 | 00333333 | 00ABABAB | 00111111 |
| | | 00121212 | 00333333 | 00ABABAB | 00111111 | 00121212 | 00333333 |
| | | 00ABABAB | 00000000 | | | | |
| 0000006F | 8 | 0000004A | 00FFF000 | 00000000 | 00000000 | 00111000 | 00000000 |
| | | 00000000 | 00000064 | | | | |
| 00000077 | 3 | 00000046 | 00000015 | 000000FF | | | |
| 0000007A | 3 | 00111111 | 00222222 | 00333333 | | | |
| 0000007D | 14 | 00111111 | 00AAAAAA | 00111111 | 00000000 | 00777777 | 00AAAAAA |
| | | 00111111 | 00000000 | 00777777 | 00AAAAAA | 00111111 | 00000000 |
| | | 00777777 | 00000000 | | | | |
| 0000008B | 3 | 00111111 | 00121212 | 00444444 | | | |
| 0000008E | 3 | 0000004B | 00000001 | 000000FF | | | |

Low Level (Processor Executable)

| | |
|---|---|
| 00000000 | B0000091 |
| 00000001 | C000000A |
| 00000002 | F0000000 |
| 00000003 | 6000004D |
| 00000004 | 80000001 |
| 00000005 | 50000000 |
| 00000006 | 1000002C |
| 00000007 | F0000002 |
| 00000008 | 80000000 |
| 00000009 | F0000064 |
| 0000000A | 20000050 |
| 0000000B | 80000001 |
| 0000000C | F0000066 |
| 0000000D | 80000000 |
| 0000000E | F0000384 |
| 0000000F | 9000005E |
| 00000010 | 80000001 |
| 00000011 | F0000386 |
| 00000012 | 80000000 |
| 00000013 | F0000640 |
| 00000014 | 80000001 |
| 00000015 | F0000641 |
| 00000016 | E0000001 |
| 00000017 | 70000007 |
| 00000018 | F0000002 |
| 00000019 | 80000000 |
| 0000001A | F0000064 |
| 0000001B | 20000061 |
| 0000001C | 80000001 |
| 0000001D | F0000066 |
| 0000001E | 80000000 |
| 0000001F | F000024E |
| 00000020 | A000006F |
| 00000021 | F00002BC |
| 00000022 | 60000077 |
| 00000023 | F00002BD |
| 00000024 | 10000004 |
| 00000025 | F0000384 |
| 00000026 | 9000007A |
| 00000027 | 80000001 |
| 00000028 | F0000386 |
| 00000029 | 80000000 |
| 0000002A | F0000640 |
| 0000002B | 80000001 |
| 0000002C | F0000641 |
| 0000002D | E0000001 |
| 0000002E | F0000002 |
| 0000002F | 80000000 |
| 00000030 | F0000064 |
| 00000031 | 2000007D |
| 00000032 | 80000001 |
| 00000033 | F0000066 |
| 00000034 | 80000000 |
| 00000035 | F0000384 |
| 00000036 | 9000008B |
| 00000037 | 80000001 |
| 00000038 | F0000386 |
| 00000039 | 80000000 |
| 0000003A | F0000640 |
| 0000003B | 80000001 |
| 0000003C | F0000641 |
| 0000003D | E0000001 |
| 0000003E | 7000002E |
| 0000003F | F000000A |
| 00000040 | 80000000 |
| 00000041 | F0000014 |
| 00000042 | 80000001 |
| 00000043 | F000001E |
| 00000044 | 80000000 |
| 00000045 | 40000000 |
| 00000046 | 10000002 |
| 00000047 | 40000000 |
| 00000048 | 10000001 |
| 00000049 | 40000000 |
| 0000004A | 6000008E |
| 0000004B | 1000000A |
| 0000004C | 40000000 |
| 0000004D | 00000048 |
| 0000004E | 00000001 |
| 0000004F | 00000001 |
| 00000050 | 00111111 |
| 00000051 | 00888888 |
| 00000052 | 00888888 |
| 00000053 | 00000000 |
| 00000054 | 00BBBBBB |
| 00000055 | 00888888 |
| 00000056 | 00888888 |
| 00000057 | 00000000 |
| 00000058 | 00BBBBBB |
| 00000059 | 00888888 |
| 0000005A | 00888888 |
| 0000005B | 00000000 |
| 0000005C | 00BBBBBB |
| 0000005D | 00000000 |
| 0000005E | 00333333 |
| 0000005F | 00555555 |
| 00000060 | 00444444 |
| 00000061 | 00111111 |
| 00000062 | 00111111 |
| 00000063 | 00121212 |
| 00000064 | 00333333 |
| 00000065 | 00ABABAB |
| 00000066 | 00111111 |
| 00000067 | 00121212 |
| 00000068 | 00333333 |
| 00000069 | 00ABABAB |
| 0000006A | 00111111 |
| 0000006B | 00121212 |
| 0000006C | 00333333 |
| 0000006D | 00ABABAB |
| 0000006E | 00000000 |
| 0000006F | 0000004A |
| 00000070 | 00FFF000 |
| 00000071 | 00000000 |
| 00000072 | 00000000 |
| 00000073 | 00111000 |
| 00000074 | 00000000 |
| 00000075 | 00000000 |
| 00000076 | 00000064 |
| 00000077 | 00000046 |
| 00000078 | 00000015 |
| 00000079 | 000000FF |
| 0000007A | 00111111 |
| 0000007B | 00222222 |
| 0000007C | 00333333 |
| 0000007D | 00111111 |
| 0000007E | 00AAAAAA |
| 0000007F | 00111111 |
| 00000080 | 00000000 |
| 00000081 | 00777777 |
| 00000082 | 00AAAAAA |
| 00000083 | 00111111 |
| 00000084 | 00000000 |
| 00000085 | 00777777 |
| 00000086 | 00AAAAAA |
| 00000087 | 00111111 |
| 00000088 | 00000000 |
| 00000089 | 00777777 |
| 0000008A | 00000000 |
| 0000008B | 00111111 |
| 0000008C | 00121212 |
| 0000008D | 00444444 |
| 0000008E | 0000004B |
| 0000008F | 00000001 |
| 00000090 | 000000FF |

While the preferred embodiments have been shown and described, it will be understood that there is no intent to limit the invention by such disclosure, but rather, it is intended to cover all modifications and alternate constructions falling within the spirit and scope of the invention as defined in the appended claims.

1. A real-time processor for a data processing system, comprising:
a continuous clock counter;
an instruction parser parsing instructions based upon whether they are a clock command or no timing specific instruction;
a clock comparator only operating upon instructions including a clock command;
means for executing a series of instructions in a timely manner based upon absolute timing of the clock counter such that events may be scheduled from the beginning of a sequence.

2. The real-time processor according to claim 1, wherein the instruction parser parses instruction based upon a delay command and the clock comparator operates upon instructions including a delay command.

3. The real-time processor according to claim 1, wherein the means for executing is an execution mechanism.

4. The real-time processor according to claim 1, wherein the clock counter operates continuously to provide for absolute time during the execution of a series of instructions.

5. The real-time processor according to claim 4, wherein the processor includes means for the explicit reset of the clock counter and the clock counter is only reset when explicitly commanded.

6. The real-time processor according to claim 1, wherein the processor is field programmable gate arrays.

7. The real-time processor according to claim 1, wherein the processor is programmed using hardware descriptive language.

8. The real-time processor according to claim 1, wherein the clock comparator includes a register loaded with values from a clock command which is compared to the current value of the clock counter.

9. The real-time processor according to claim 1, wherein the instruction parser parses input instructions and the real-time processor further includes an input operator, the input operator including means for executing an input instruction upon receipt of an input signal and the output operator.

10. The real-processor according to claim 9, wherein the instruction parser further parses output instructions and the real-time processor includes a output operator including means for executing an output instruction based upon receipt of an input signal by the input operator.

11. The real-processor according to claim 9, wherein the input operator includes a time register and comparator

12. The real-processor according to claim 11, wherein the comparator of the input operator includes means for comparing the time register of the input operator with the clock counter of the real-time processor.

13. The real-processor according to claim 1, further including means for generating single event output and serial outputs in precise time synchronization.

14. The real-time processor according to claim 1, further including an oscillator scaler issuing counter enable signals controlling operation of the clock counter to increment on a predetermined time scale, and means for controlling the oscillator scaler to alter the issuance of counter enable signals.

15. A launch station test set which emulates a control system and missiles to step the launcher through a simulated launch with time critical issues, comprising:
a missile launcher;
a missile simulator;
a real time processor including a continuous clock counter, an instruction parser parsing instructions based upon whether they a clock command or no timing specific instruction, a clock comparator only operating upon instructions including a clock command, and means for executing a series of instructions in a timely manner based upon absolute timing of the clock counter such that events may be scheduled from the beginning of a sequence.

16. A engagement control system—factory test emulator which emulates precision signals issued over a serial data link, the signals and serial data link are synchronized due to serial messages such that missiles are synchronized with messages to operate in tandem, comprising:
a launching system;
a real time processor including a continuous clock counter, an instruction parser parsing instructions based upon whether they a clock command or no timing specific instruction, a clock comparator only operating upon instructions including a clock command, and means for executing a series of instructions in a timely manner based upon absolute timing of the clock counter such that events may be scheduled from the beginning of a sequence.

17. A real-time processor for a data processing system, comprising:
a continuous clock counter;
an instruction parser parsing instructions based upon whether they are an input instruction;
an input operator, the input operator including means for executing an input instruction upon receipt of an input signal and the output operator.

18. The real-processor according to claim 17, wherein the instruction parser further parses output instructions and the real-time processor includes a output operator including means for executing an output instruction based upon receipt of an input signal by the input operator.

19. The real-processor according to claim 17, wherein the input operator includes a time register and comparator

20. The real-processor according to claim 19, wherein the comparator of the input operator includes means for comparing the time register of the input operator with a clock counter of the real-time processor.

21. The real-time processor according to claim 20, wherein the means for comparing includes means for determining a valid input when the comparator and time register of the input operator indicate required input within a required timing window.
